(19) United States
(12) Patent Application Publication
(10) Pub. No.: US 2022/0229955 A1
(43) Pub. Date: Jul. 21, 2022

(54) ANALYSIS METHOD, ANALYSIS DEVICE, AND PROGRAM

(71) Applicant: SUMITOMO HEAVY INDUSTRIES, LTD., Tokyo (JP)

(72) Inventor: Shuji Miyazaki, Kanagawa (JP)

(21) Appl. No.: 17/580,155

(22) Filed: Jan. 20, 2022

(30) Foreign Application Priority Data
Jan. 21, 2021 (JP) 2021-007939

(51) Int. Cl. G06F 30/20

(52) U.S. Cl. CPC G06F 30/20; G06F 2111/10

(57) ABSTRACT

A magnetic field analysis method includes: dividing each analysis object of a system including at least one analysis object into a plurality of beads; applying a magnetic moment to each bead; and obtaining an induced magnetic field at a position of each bead when an external magnetic field changes over time, in which each bead is divided into a plurality of triangular pyramid or triangular elements, a vector potential at an observation point included in a virtual space is described as a function of an electromagnetic physical quantity in a minute region in the analysis object and a distance from the minute region to the observation point, and the induced magnetic field at the observation point is obtained by numerically volume-integrating or surface-integrating the function of the vector potential for each of the elements obtained by division.

### RELATED APPLICATIONS

The content of Japanese Patent Application No. 2021-007939, on the basis of which priority benefits are claimed in an accompanying application data sheet, is in its entirety incorporated herein by reference.

### BACKGROUND

### Technical Field

Certain embodiments of the present invention relate to an analysis method, an analysis device, and a program for performing magnetic field analysis.

### Description of Related Art

As a method for researching phenomena of general material science by using a calculator based on classical mechanics, quantum mechanics, or the like, a simulation based on a renormalized molecular dynamics method in which a molecular dynamics method is developed to handle a macroscale system is known (refer to, for example, the related art) . Since a particle method such as the molecular dynamics method handles not only a static phenomenon but also a dynamic phenomenon such as flow, the particle method attracts attention as a simulation method replacing a finite element method, which mainly analyzes a static phenomenon, or the like. Further, a magnetic bead method that can obtain a simulation result with comparatively high accuracy at a high speed by applying a magnetic moment to each particle and calculating a magnetic physical quantity by using an exact solution based on spherical symmetry of each particle has been proposed (refer to, for example, the related art).

### SUMMARY

According to an embodiment of the present invention, there is provided a magnetic field analysis method including:
dividing each of analysis objects of a system including at least one analysis object that is defined in a virtual space into a plurality of beads, each of which is a Voronoi polyhedron or a Voronoi polygon;
applying a magnetic moment to each of the plurality of beads; and
obtaining an induced magnetic field at a position of each of the plurality of beads when an external magnetic field changes over time,
in which each of the plurality of beads is divided into a plurality of triangular pyramid elements each having each of a plurality of Voronoi surfaces of the Voronoi polyhedron as a bottom surface, or a plurality of triangular elements each having each of a plurality of sides of the Voronoi polygon as one side,
a vector potential at an observation point that is included in the virtual space is described as a function of an electromagnetic physical quantity in a minute region in the analysis object and a distance from the minute region to the observation point, and
the induced magnetic field at the observation point is obtained by numerically volume-integrating or surface-integrating the function of the vector potential for each of the elements obtained by division.

According to another embodiment of the present invention, there is provided an analysis device including:
an input device to which an analysis condition is input; and
a processing device that performs analysis of a magnetic field, based on the analysis condition input to the input device,
in which a vector potential at an observation point that is included in a virtual space is described as a function of an electromagnetic physical quantity in a minute region in an analysis object and a distance from an optional point in the minute region to the observation point,
the processing device is capable of
applying a magnetic moment to each of a plurality of beads,
dividing each of the analysis objects of a system including at least one analysis object that is defined in the virtual space into the plurality of beads, each of which is a Voronoi polyhedron or a Voronoi polygon, based on the analysis condition input to the input device, and
obtaining an induced magnetic field at a position of each of the plurality of beads when an external magnetic field changes over time, and
in the obtaining of the induced magnetic field,
each of the plurality of beads is divided into a plurality of triangular pyramid elements each having each of a plurality of Voronoi surfaces of the Voronoi polyhedron as a bottom surface, or a plurality of triangular elements each having each of a plurality of sides of the Voronoi polygon as one side, and
the induced magnetic field at the observation point is obtained by numerically volume-integrating or surface-integrating the function of the vector potential for each of the elements obtained by division.

According to still another embodiment of the present invention, there is provided a computer readable medium storing a program that causes a computer to execute a process for magnetic analysis, the process including:
dividing each of analysis objects of a system including at least one analysis object that is defined in a virtual space into a plurality of beads each of which is a Voronoi polyhedron,
applying a magnetic moment to each of the plurality of beads, and
obtaining an induced magnetic field at a position of each of the plurality of beads when an external magnetic field changes over time,
in which a vector potential at an observation point that is included in the virtual space is described as a function of an electromagnetic physical quantity in a minute region in the analysis object and a distance from an optional point in the minute region to the observation point, and
the obtaining of the induced magnetic field includes
dividing each of the plurality of beads into a plurality of triangular pyramid elements each having each of a plurality of Voronoi surfaces of the Voronoi polyhedron as a bottom surface, or a plurality of triangular elements each having each of a plurality of sides of a Voronoi polygon as one side, and
obtaining the induced magnetic field at the observation point by numerically volume-integrating or surface-integrating the function of the vector potential for each of the elements obtained by division.

### BRIEF DESCRIPTION OF THE DRAWINGS

FIG. 1 is a block diagram of an analysis device according to an example.

FIG. 2 is a flowchart showing a procedure for an analysis method according to the example.

FIG. 3A is a schematic diagram showing an example of an analysis model, and FIG. 3B is a schematic diagram showing an observation point in an analysis space and one bead.

FIG. 4A is a schematic diagram for explaining a method of dividing a two-dimensional circular analysis object into a plurality of beads, and FIG. 4B is a schematic diagram of one bead.

FIG. 5A is a schematic diagram showing an example of one bead among a plurality of beads that are Voronoi polyhedra which are included in the analysis object in a case where a virtual space is three-dimensional, and FIG. 5B is a schematic diagram showing a plurality of triangular pyramid elements each having one Voronoi surface as a bottom surface.

FIG. 6A is a schematic diagram showing an analysis model, and FIG. 6B is a graph showing analysis results.

FIG. 7 is a chart showing errors from an exact solution, of solutions obtained by analysis methods according to an example and a comparative example.

### DETAILED DESCRIPTION

In the magnetic bead method described above, an object is divided into a plurality of elements, each element is regarded as a spherical particle, and a magnetic field is calculated using an exact solution based on spherical symmetry. When trying to fill the object with a plurality of particles, a gap is generated between the particles, and therefore, an error due to the gap or the spherical particle may occur.

In the analysis of an induction motor, it is desired to make an error in induced magnetic field analysis 1% or less in order to obtain a torque near a rated rotating speed. Further, in a case of performing the induced magnetic field analysis of a magnetic shield that is used under a cryogenic temperature condition, conductivity becomes several hundred times that at room temperature. If the conductivity is high, an error in the induced magnetic field analysis becomes large. In the magnetic bead method of the related art, it is difficult to make the error of the induced magnetic field analysis equal to or less than the target value described above.

It is desirable to provide an analysis method, an analysis device, and a program, in which it is possible to reduce an error in magnetic field analysis.

Since the function of the vector potential is numerically volume-integrated or surface-integrated for each of the elements obtained by dividing each of the beads, almost the entire area of the analysis object is an integral range, and a gap is not generated in the integral range. Therefore, the analysis accuracy can be improved as compared with a method of the related art, in which a bead is assumed to be a true circle or a true sphere and an integral range is set to be a true circle or a true sphere.

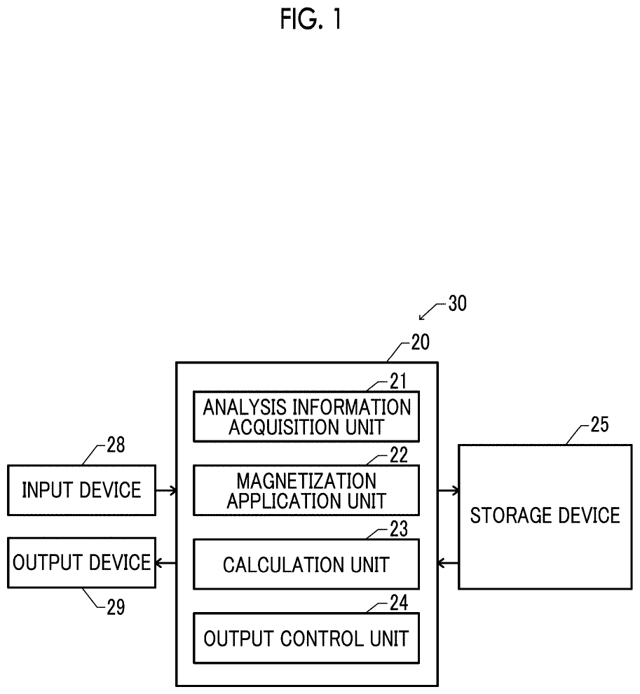

An analysis device and an analysis method according to an example of the present invention will be described with reference to FIGS. 1 to 7.

As a method for researching phenomena of general material science by using a calculator based on classical mechanics, quantum mechanics, or the like, a simulation based on a molecular dynamics method (hereinafter, referred to as an MD method) , a quantum molecular dynamics method, or a renormalized molecular dynamics method (hereinafter, referred to as an RMD method) in which the MD method is developed to handle a macroscale system is known. To be precise, the MD method or the RMD method is a kinetic method (statistical mechanics is used in calculation of a physical quantity), and the particle method is a method of discretizing a differential equation describing a continuum. Although the MD method or the RMD method and the particle method are different from each other, here, the MD method or the RMD method is also referred to as the particle method.

Since the particle method can handle not only a static phenomenon but also a dynamic phenomenon such as flow, the particle method attracts attention as a simulation method replacing a finite element method, which mainly analyzes a static phenomenon, or the like.

The particle method has a differential view that a particle system to be analyzed is obtained by discretizing a continuum with particles. For example, in a case where a fluid is handled in the particle method, the Navier-Stokes equation is often discretized with particles.

On the other hand, as another view of the particle method, there is also an integral view that a continuum is formed by collecting many particles. This is, for example, a view that a large iron ball is formed by collecting and solidifying small iron grains.

In general, in a case of obtaining a magnetic field at a certain point (observation point) in a space where many magnetic moments exist, the magnetic field that is generated at the observation point by each magnetic moment is summed over the magnetic moments due to a superposition principle. The inventor of the present invention has uniquely found affinity between the method of obtaining the magnetic field from a collection of such magnetic moments and the particle method in the integral view, and has devised the application of a magnetic moment to a particle (bead) in the particle method. In this way, it is possible to extend the application range of the particle method to the magnetic field analysis while maintaining the advantage of the particle method that the particle method is effective for analysis of convection or large deformation. In the present specification, a method of performing magnetic field analysis by applying a magnetic moment to each bead is referred to as a magnetic bead method.

By representing an object as an aggregate of spherical beads and using an exact solution based on spherical symmetry of each particle, it is possible to obtain a calculation result at high speed and with high accuracy. However, in a case where an object that is a continuum is represented by an aggregate of spherical beads, a gap is generated between the beads, and therefore, a calculation error due to the gap occurs. In particular, the influence of an error becomes large when calculating a magnetic field near a bead in a case where a distance between beads is smaller.

In the analysis device and the analysis method according to an example described below, it is possible to divide an analysis object into a plurality of beads such that no gap is generated, and to reduce an error due to a gap that is generated between the beads.

FIG. 1 is a block diagram of an analysis device 30 according to the present example. The analysis device 30 according to the present example includes a processing device 20, a storage device 25, an input device 28, and an output device 29. The processing device 20 includes an analysis information acquisition unit 21, a magnetization application unit 22, a calculation unit 23, and an output control unit 24.

Each block shown in FIG. 1 can be realized by an element, such as a central processing unit (CPU) of a computer, or a mechanical device in terms of hardware, and can be realized by a computer program or the like in terms of software. In FIG. 1, functional blocks that are realized by the cooperation of hardware and software are shown. Accordingly, these functional blocks can be realized in various aspects by the combination of hardware and software.

The processing device 20 is connected to the input device 28 and the output device 29. The input device 28 receives an input of a command from a user and data related to processing which is executed in the processing device 20. As the input device 28, for example, a keyboard or a mouse that is operated by a user to perform the input, a communication device that performs the input through a network such as the Internet, a reading device that performs the input from a removable medium such as a CD or a DVD, or the like can be used.

The analysis information acquisition unit 21 acquires magnetic field analysis information through the input device 28. Various kinds of information necessary for magnetic field analysis are included in the magnetic field analysis information. For example, the shape of an analysis object that is defined in a virtual space, information for dividing the analysis object into a plurality of beads, the physical property value of the analysis object, and the like are included in the magnetic field analysis information.

The magnetization application unit 22 divides the analysis object in the virtual space into a plurality of beads, based on the magnetic field analysis information. A bead identifier (bead ID) for specifying the bead is applied to each of the plurality of beads. The magnetization that is applied to the bead may be applied as an initial condition, or the magnetization that is generated in each bead may be calculated based on an external magnetic field obtained by the calculation unit 23 (described later), and a magnetic moment based on the magnetization obtained by the calculation may be applied. Since the magnetization is a value per unit volume of the vector sum of a total magnetic moments in the bead, the magnetic moment that is applied to the bead can be obtained from the magnetization obtained for each bead. The magnetization application unit 22 stores information on the applied magnetic moment in association with the bead ID in the storage device 25.

The calculation unit 23 calculates magnetic fields at a plurality of observation points in the virtual space, based on the magnetic moment applied to the bead, and stores the calculation result in the storage device 25. The observation point is disposed at the center position of each of the beads, for example . The calculation that is performed by the calculation unit 23 will be described in detail later.

The output control unit 24 outputs the analysis result, for example, the calculation result of the magnetic field for each observation point stored in the storage device 25, to the output device 29.

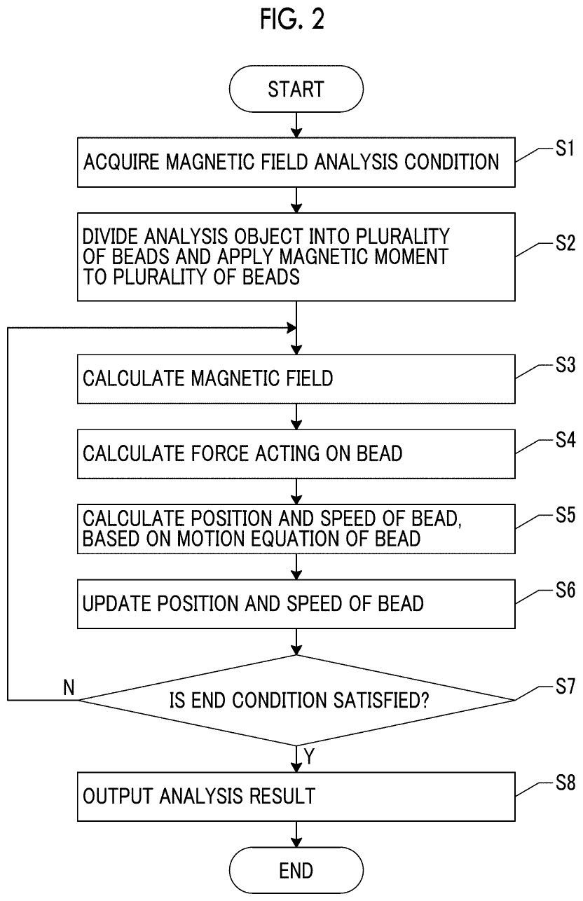

FIG. 2 is a flowchart showing a procedure for the analysis method according to the present example.

First, the analysis information acquisition unit 21 (FIG. 1) acquires a magnetic field analysis condition (step S1). The magnetization application unit 22 (FIG. 1) divides the analysis object into a plurality of beads, and applies a magnetic moment to each of the plurality of beads (step S2). As an example, the initial value of the magnetic moment that is applied to each bead is zero.

Next, the calculation unit 23 calculates a magnetic field in the analysis object and a magnetic field in the virtual space in which the analysis object is disposed (step S3). For example, an iteration method is applied to the calculation of the magnetic field. In the iterative calculation, the magnetic moment applied to the bead is updated for each time step. Further, the calculation unit 23 calculates a force acting on the bead, based on the magnetic field obtained in step S3 and the magnetic moment applied to each bead (step S4). After the force acting on the bead is obtained, the calculation unit 23 calculates the position and speed of the bead by numerically solving a motion equation that governs the motion of the bead (step S5). Thereafter, the current position and speed of the bead are updated based on the position and speed obtained in step S5 (step S6).

The procedure from step S3 to step S6 is repeated until an analysis end condition is satisfied (step S7). When the analysis is ended, the output control unit 24 (FIG. 1) outputs the analysis result to the output device 29 (step S8).

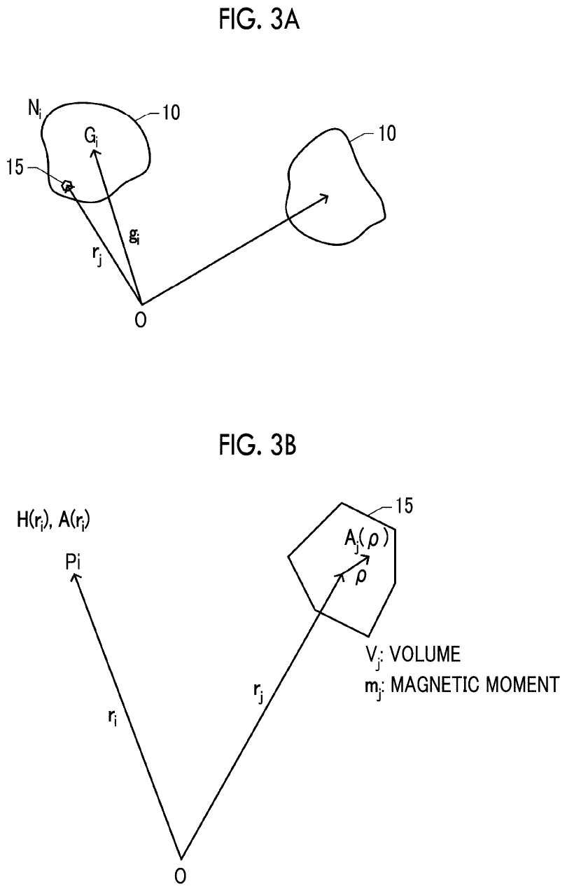

Next, an analysis model and a coordinate system will be described with reference to FIGS. 3A and 3B.

FIG. 3A is a schematic diagram showing an example of the analysis model. At least one analysis object 10, for example, two analysis objects 10 are disposed in the virtual space. The origin of a coordinate system that is defined in the virtual space is marked as O. Each of the analysis objects 10 is divided into a plurality of beads 15. The number of beads 15 that are included in the i-th analysis object 10 is marked as Nᵢ. In FIG. 3A, one bead 15 of one analysis object 10 is shown. A position vector of the j-th bead 15 is marked as rⱼ. A position vector of a centroid Gᵢ of the i-th analysis object 10 is marked as gᵢ. In the drawing, the symbols representing the vectors are shown in boldface. In the present specification, there is a case where the position that is represented by a position vector r is referred to as a position r.

FIG. 3B is a schematic diagram showing an observation point Pᵢ in the analysis space and one bead 15. The position of the i-th observation point Pᵢ for which a magnetic field is calculated is marked as rᵢ and the position of the j-th bead 15 that exerts electromagnetic action on the observation point Pᵢ is marked as rⱼ. In the present specification, there is a case where the bead 15 that exerts electromagnetic action on the observation point Pᵢ is referred to as a bead serving as a source. There area case where the observation point Pᵢ is located in the analysis object 10 that includes the bead 15 serving as a source and a case where the observation point Pᵢ is located in the analysis object 10 different from the analysis object 10 that includes the bead 15 serving as a source.

A magnetic field vector H(rᵢ) and a vector potential A(rᵢ) are defined at the observation point Pᵢ. A magnetic moment mⱼ is applied to the j-th bead 15 whose centroid position is defined by the position vector rⱼ. The volume of the j-th bead 15 is marked as Vⱼ. Further, in the j-th bead 15, the vector potential at the position that is represented by a vector ρ from the centroid position of the bead 15 is marked as Aⱼ (ρ).

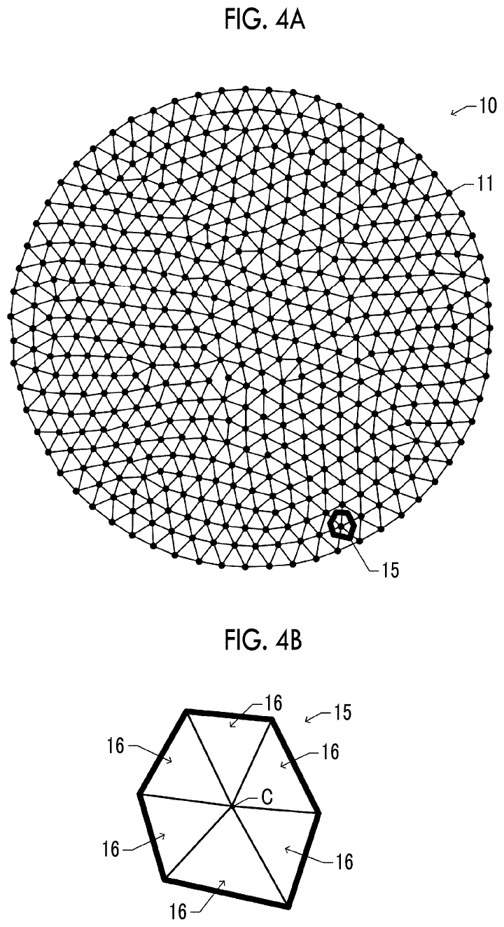

Next, a method of dividing the analysis object 10 into a plurality of beads 15 will be described with reference to FIG. 4A.

FIG. 4A is a schematic diagram for explaining a method of dividing a two-dimensional circular analysis object 10 into a plurality of beads 15. First, a mesh is created in the analysis object 10 by using a known algorithm. For example, the Deloni division method can be applied to create the mesh. In this way, a plurality of nodes 11 are disposed in the analysis object 10. Ina case where the virtual space is two-dimensional, the analysis object 10 is divided into a plurality of triangular elements, and the vertex of the triangular element becomes the node 11. In a case where the virtual space is three-dimensional, the analysis object 10 is divided into a plurality of tetrahedra, and the vertex of the tetrahedron becomes the node 11.

The analysis object 10 is Voronoi-divided such that each of the plurality of nodes 11 becomes a generatrix. In this way, in a case where the virtual space is two-dimensional, a plurality of Voronoi polygons are formed, and in a case where the virtual space is three-dimensional, a plurality of Voronoi polyhedra are formed. Each of the Voronoi polygons or Voronoi polyhedra formed by the Voronoi division of the analysis object 10 is defined as the bead 15.

Next, preferable dimensions of the bead 15 will be described. The radius of the minimum inclusion circle of the bead 15 is marked as a. In a case where the analysis object 10 (FIG. 4A) is a conductor, an eddy current is generated due to a time change of an external magnetic field. In order to sufficiently reflect the influence of an induced magnetic field, which is generated by the eddy current, in the analysis result, it is preferable to make the radius a sufficiently smaller than the depth of a skin due to the skin effect. Specifically, it is preferable to set the radius a so as to satisfy the following expression.

$$\sqrt{\frac{2}{μσω}} ⪢ a \qquad ( 1 )$$

Here, μ and σ are the magnetic permeability and the conductivity of the analysis object 10, respectively. Further, co is an angular frequency of the magnetic field that is applied from the outside.

### Vector Potential Calculation

A method of calculating the vector potential that is applied in the present example will be described.

The following differential equation is established with respect to a vector potential A.

$$μ σ \frac{\partial A ( r )}{\partial t} = {∇}^{2} A ( r ) \qquad ( 2 )$$

Here, r is a position vector, μ is magnetic permeability, σ is conductivity, and A is a vector potential. The solution of the differential equation that is expressed by Expression (2) is as follows.

$$A ( r ) = - \frac{μ}{4 π} \int {d}^{3} {r}^{′} \frac{σ ( {r}^{′} ) \dot{A} ( {r}^{′} )}{\vert r - {r}^{′} \vert} \qquad ( 3 )$$

The integral on the right side of Expression (3) is performed over the entire space with respect to a position vector r′.

The position vector r′ is marked as follows by using a position vector rⱼ of the j-th bead 15.

A vector potential A(rᵢ) at a position vector rᵢ is expressed by the following expression from Expressions (3) and (4).

$$A ( {r}_{1} ) = - \frac{μ}{4 π} {\sum }_{j}^{N} \int {d}^{3} {r}^{′} \frac{σ ( {r}^{′} ) \dot{A} ( {r}^{′} )}{\vert r - {r}^{′} \vert} = - \frac{μ}{4 π} {\sum }_{j}^{N} {\int }_{{V}_{j}} {d}^{3} ρ \frac{{σ}_{j} {\dot{A}}_{j} ( ρ )}{\vert {r}_{ij} - ρ \vert} \qquad ( 5 )$$

Here, N is the number of beads 15 in the entire system, Vⱼ is the volume of the j-th bead 15 (FIG. 3B) , and rᵢⱼ is defined by the following expression.

rᵢⱼ=rᵢ−rⱼ (6)

Further, Aⱼ(ρ) (FIG. 3B) , which is a function before the time derivative of Aⱼ (ρ) dot on the right side of Expression (5), is defined by the following expression.

Aⱼ(ρ)=A(rⱼ+ρ) (7)

The integral on the right side of Expression (5) means the volume integration for the j-th bead, and the sigma symbol means summing over the N beads in the entire system. The conductivity is assumed to be constant in one bead 15, and the conductivity of the j-th bead is marked as σⱼ.

Due to dividing the analysis object 10 into a plurality of beads 15, there is a concern that the translational symmetry of the vector potential A may be lost. The inventor of the present invention has found that the translational symmetry of the vector potential A can be restored by introducing the following gauge transformation that is described by using the vector product of the magnetic flux density and the centroid vector for each of the analysis objects 10.

Aⱼ(ρ)→Aⱼ(ρ)−½Bⱼ×gᵢ (8)

Here, Bⱼ is the magnetic flux density at the position of the j-th bead 15. gᵢ is the centroid vector of the i-th analysis object 10 (FIG. 3A) and is defined by the following expression.

$${g}_{1} = \frac{1}{{N}_{i}} {\sum }_{j}^{{N}_{i}} {r}_{j} \qquad ( 9 )$$

Here, Nᵢ is the number of beads 15 that are included in the i-th analysis object 10 (FIG. 3A), and the sigma symbol on the right side means that all beads 15 in the i-th analysis object 10 are added together.

When the relational expression between the magnetic flux density that is expressed by the following Expression (10) and the vector potential is obtained with respect to the gauge transformation shown in Expression (8), Expression (11) is obtained.

$$\begin{matrix}B ( {r}_{j} ) = ∇ \times {A}_{j} ( ρ ) & ( 10 ) \\ B ( {r}_{j} ) = ( 1 - \frac{1}{{N}_{i}} ) {B}_{j} = {B}_{j} + O ( \frac{1}{{N}_{i}} ) & ( 11 )\end{matrix}$$

Here, the function O(1/Nᵢ) can be approximated to a zero vector when Nᵢ is sufficiently large. Therefore, it can be seen that the translational symmetry is satisfied in a case where the number of beads Nᵢ of the i-th analysis object 10 is sufficiently large.

From the gauge transformation shown in Expression (8), the Aⱼ(ρ) dot that is included in the right side of Expression (5) can be expressed by the following expression.

Aⱼ(ρ)=1/2Bⱼ×(dⱼᵢ+ρ) (12)

dⱼᵢ=rⱼ−gᵢ (13)

From Expressions (12) and (13), the time derivative of the vector potential Aⱼ(ρ) is expressed by the following expression.

Aⱼ(ρ)=½Bⱼ×(rⱼ+ρ)−½Bⱼ×gᵢ (14)

When Expression (14) is substituted for Expression (5) and an integral is executed, the vector potential A can be described using the time derivative of the magnetic flux density B.

### Numerical Calculation of Vector Potential

Next, a method of numerically calculating the vector potential A that is expressed by Expression (3) will be described. In the following description, a case where the virtual space is two-dimensional will be described.

In a case where the virtual space is two-dimensional, Expression (3) is rewritten as follows.

$$A ( r ) = - \frac{μ}{4 π} {\int }_{{S}^{′}} σ ( {r}^{′} ) \dot{A} ( {r}^{′} ) ln ( \frac{1}{\vert r - {r}^{′} \vert} ) {dS}^{′} \qquad ( 15 )$$

The integral on the right side of Expression (15) means an integral in a minute region having an area S′. r′ is a position vector of the minute region having the area S′. Expression (15) is described with the vector potential A(r) at the observation point that is included in the virtual space as a function of an electromagnetic physical quantity o and A dot in the minute region S′ in the analysis object and the distance (r-r′) from the minute region to the observation point.

When the conductivity and the time derivative value of the vector potential are assumed to be constant inside the bead, the conductivity in the j-th bead 15 is marked as σⱼ, and the time derivative value of the vector potential A is marked as Aⱼ dot, Expression (15) is transformed as follows.

$$A ( r ) = - \frac{μ}{4 π} {\sum }_{j = 0}^{{N}_{i}} {σ}_{j} {\dot{A}}_{j} {\int }_{{S}^{′}} \cdot ln ( \frac{1}{\vert r - {r}^{′} \vert} ) {dS}_{j}^{′} \qquad ( 16 )$$

Here, the integral on the right side of Expression (16) means a surface integration in the j-th bead 15.

Next, a method of numerically performing the integral on the right side of Expression (16) will be described with reference to FIG. 4B.

FIG. 4B is a schematic diagram of one bead 15. The bead 15 is shown as a Voronoi polygon. The bead 15 is divided into a plurality of triangular elements 16 each having each of the plurality of sides of the bead 15 as a base and the centroid C of the bead 15 as a vertex. The surface integration on the right side of Expression (16) is performed for each of the triangular elements 16. For example, the Gauss-Legendre's numerical integration method can be applied to the surface integration.

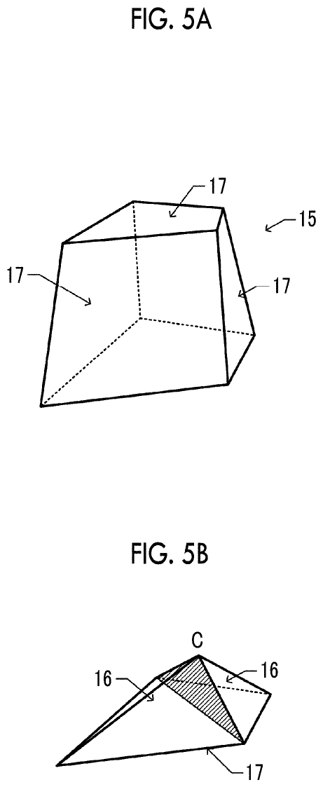

Next, the numerical integration in a case where the virtual space is three-dimensional will be described with reference to FIGS. 5A and 5B.

FIG. 5A is a schematic diagram showing an example of one bead 15 among a plurality of beads 15 that are Voronoi polyhedra which are included in the analysis object 10 (FIG. 3A) in a case where the virtual space is three-dimensional. The bead 15 is configured with a plurality of Voronoi surfaces 17. In order to perform a numerical volume integration on the bead 15, each of the beads 15 is divided into a plurality of elements 16 (FIG. 5B) , each of which is a triangular pyramid (tetrahedron) having the Voronoi surface 17 as a bottom surface.

FIG. 5B is a schematic diagram showing a plurality of triangular pyramid elements 16 each having one Voronoi surface 17 as a bottom surface. First, the Voronoi surface 17 that is a polygon is divided into a plurality of triangular elements each having each vertex of the Voronoi surface 17 as a vertex. In a case where the Voronoi surface 17 is a quadrangle, two triangular elements are formed with respect to the Voronoi surface 17. The plurality of triangular pyramid elements 16 each having each of the triangular elements as a bottom surface and the centroid C of the bead 15 as a vertex are formed. In FIG. 5B, the surface that is shared by the two elements 16 is hatched. The bead 15 is divided into the plurality of elements 16 by likewise forming the plurality of triangular pyramid elements 16 with respect to all the Voronoi surfaces 17.

The volume integration value on the right side of Expression (5) can be obtained for each bead 15 by applying the Gauss-Legendre's numerical integration method for each of the triangular pyramid elements 16.

Calculation of Magnetic Flux Density, Magnetic Field Vector, Magnetization Vector, and Magnetic Moment in Magnetic Material

Next, the calculation of the magnetic flux density, the magnetic field vector, and the time derivative value of the magnetic flux density in the bead 15 will be described. The magnetic flux density that is generated at the position vector rᵢ inside a magnetic body can be expressed by the following expression.

B(rᵢ)=μ₀{Hₒ(rᵢ)+(1−αᵢ)M(H)} (17)

Here, rᵢ is a position vector at an optional position, Hₒ (rᵢ) is a total external magnetic field vector at the position vector rᵢ, and M (H) is a magnetization vector. The magnetization vector M(H) depends on a magnetic field vector H. αᵢ is a demagnetization coefficient at the position of the i-th bead. The value of αᵢ is determined according to the shape of the i-th bead. For example, in a case where the shape of the i-th bead is a true sphere, αᵢ=⅓. Ina case where the shape of the i-th bead is a polyhedron, αᵢ can be calculated from an expression (value of the magnetic field vector acting on itself) in which j=i in Expression (5).

The magnetic field vector at the position vector rᵢ in the magnetic body is expressed by the following expression.

H(rᵢ)=Hₒ(rᵢ)−αᵢM(H) (18)

The time derivative value of the magnetic flux density can be expressed by the following expression.

$$\dot{B} ( {r}_{1} ) = {μ}_{0} \frac{1 + χ ( H )}{1 + {α}_{i} χ ( H )} {\dot{H}}_{o} ( {r}_{1} ) \qquad ( 19 )$$

Here, X(H) is magnetic susceptibility and depends on the magnetic field vector.

The total external magnetic field vector Hₒ(rᵢ) is expressed by the following expression.

Hₒ(rᵢ)=Hₘ(rᵢ)+Hₑₓₜ(rᵢ)+H_{ind}(rᵢ) (20)

Here, Hₘ(rᵢ) is a magnetic field vector due to a magnetic moment in the magnetic body, Hₑₓₜ(rᵢ) is an external magnetic field vector that is applied from the outside, and H_{ind}(rᵢ) is an induced magnetic field vector caused by an induced current that is generated in the analysis object 10 when the external magnetic field changes over time.

The magnetization vector M(H) of Expressions (17) and (18) is expressed by the following expression in a case where the magnetic material is a linear material.

$$M ( H ) = \{ \frac{μ - {μ}_{0}}{μ + {μ}_{0} ( 1 - {α}_{i} )} \} {H}_{o} ( {r}_{i} ) \qquad ( 21 )$$

Here, μ and μ₀ are the magnetic permeability of the magnetic body and the magnetic permeability of vacuum, respectively. In a case where the magnetic material is a non-linear material, the magnetization vector M(H) is expressed by the following expression.

M(H)=f(H) (22)

The function f(H) is a function that characterizes the non-linear magnetic material. When the function f is given, the magnetization vector M can be described as a function of the total external magnetic field vector Hₒ(rᵢ) from Expressions (18) and (22).

In a case of obtaining the magnetic flux density in the i-th bead 15 and the time derivative value of the magnetic flux density, it is favorable if the center position of the bead 15 is substituted for the position vector rᵢ of Expressions (17) and (19) . In a case where the analysis object 10 is a non-magnetic body, the magnetization vector M is zero and the magnetic susceptibility x is also zero.

In a case where the magnetic body is a linear magnetic material, when the total external magnetic field vector Hₒ(rᵢ) of Expression (20) is obtained, the magnetization vector M at the position vector rᵢ can be obtained from. Expression (21). In a case where the magnetic body is a non-linear magnetic material, the magnetization vector Mat the position vector rᵢ can be obtained from an expression in which the magnetization vector M is described as a function of the total external magnetic field vector Hₒ(rᵢ) by using Expressions (18) and (22). The magnetic moment mᵢ to be applied to the i-th bead 15 can be obtained from the magnetization vector M at the position vector rᵢ.

### Calculation of External Magnetic Field by Magnetic Moment in Magnetic Body

A method of calculating the external magnetic field Hₘ by the magnetic moment in the magnetic body is described in detail in Japanese Patent No. 6249912. Here, the method of calculating the external magnetic field Hₘ by the magnetic moment in the magnetic body will be briefly described.

The magnetic moment applied to the j-th bead 15 in the virtual space is marked as mⱼ. The magnetic moment mⱼ is expressed as follows by using each component of the xyz Cartesian coordinate system.

mⱼ=(mⱼₓ,m_{jy},m_{jz})=MⱼVⱼ (23)

Here, Mⱼ is the magnetization vector of the j-th bead 15, and Vⱼ is the volume of the j-th bead 15.

The external magnetic field vector Hₘ(rᵢ) at the position vector rᵢ is expressed by the following expression.

$${H}_{m} ( {r}_{1} ) = {\sum }_{j \neq i}^{N} [ H ( {r}_{ij} ; {m}_{jx} ) + H ( {r}_{ij} ; {m}_{jy} ) + H ( {r}_{ij} ; {m}_{jz} ) ] \qquad ( 24 )$$

Here, the magnetic field vector H (rᵢⱼ;mⱼₓ) means an external magnetic field vector that is generated at a position of a distance rᵢ from the j-th bead 15 by an x-component of the magnetic moment mⱼ applied to the j-th bead 15. The distance rᵢⱼ is the distance from the position represented by the position vector rᵢ to the centroid position of the j-th bead 15. The sigma on the right side of Expression (24) means that the action from the magnetic moment mᵢ applied to the j-th bead 15 other than the bead 15 located in the position vector rᵢ is summed. Since the detailed calculation method of the magnetic field vector H(rᵢⱼ;mⱼₓ) and the like is described in Japanese Patent No. 6249912, detailed description thereof will be omitted here.

### Induced Magnetic Field Calculation

Next, a method of calculating the induced magnetic field in the analysis object 10 will be described.

The total external magnetic field vector Hₒ(rᵢ) acting on the observation point Pᵢ (FIG. 3B) in the analysis object 10 (FIG. 3A) is expressed by Expression (20) . The total external magnetic field vector Hₒ(rᵢ) at the position of each of the plurality of beads 15 is obtained using Expression (20) . The magnetic field vector Hₘ(rᵢ) on the right side of Expression (20) can be calculated using Expression (24). The magnetic field vector Hₑₓₜ(rᵢ) that is applied from the outside is given as an analysis condition. The current induced magnetic field vector H_{ind}(rᵢ) is known, and the induced magnetic field vector H_{ind}(rᵢ) after one time step elapses is calculated using an iteration method. The initial value of the induced magnetic field vector H_{ind}(rᵢ) is, for example, zero.

The following motion equation is numerically solved by associating the total external magnetic field vector Hₒᵢ at the position of the i-th bead 15 and the time derivative value of the total external magnetic field vector Hₒᵢ with the position and speed of a dynamical system, respectively.

$${m}_{v} \frac{d {\dot{H}}_{oi}}{dt} = - [ {H}_{o 1} - {H}_{o} ( {r}_{1} ) ] \qquad ( 25 )$$

Here, mᵥ is a virtual mass. The recommended value of the virtual mass is about 250 times the square of a time step width. When the virtual mass mᵥ is made sufficiently small, minute damped vibration occurs in the vicinity of the correct solution, and an error can be reduced. Hₒ(rᵢ) is the current total external magnetic field vector at the position vector rᵢ and is calculated by Expression (20). For example, a frog-flying method can be used for the numerical calculation of the motion equation of Expression (25).

When the total external magnetic field vector Hₒᵢ and its time derivative value are obtained, the magnetic flux density vector Bᵢ at the position of the i-th bead 15 and its time derivative value Bᵢ dot are obtained for all i by using Expressions (17) and (19).

Next, the vector p in Expression (14) is set to be zero, and the time derivative value Aⱼ dot of the vector potential Aⱼ at the position of the j-th bead is obtained for all j. Next, the vector potential Aᵢ at the position of the i-th bead 15 is obtained for all i by using Expression (16).

When the vector potential A_{d} is obtained, the induced magnetic field vector H_{ind}(rᵢ) at the centroid position vector rᵢ of the i-th bead 15 is updated for all i by using the following expression.

$${H}_{ind} ( {r}_{1} ) = \frac{1}{μ} ∇ \times A ( {r}_{1} ) \qquad ( 26 )$$

The partial differentiation of the vector potential A(rᵢ) on the right side of Expression (22) is numerically calculated by calculating the vector potential at a position deviated by a minute distance in x, y, and z directions from the position represented by the position vector rᵢ by using Expression (16) and taking a difference. For example, the x-component H_{ind,x}(rᵢ) of the induced magnetic field vector H_{ind}(rᵢ) can be calculated by the following expression.

$${H}_{ind , x} ( {r}_{1} ) = \frac{1}{μ} \{ \frac{{A}_{z} ( {x}_{i} , {y}_{i} + dy , {z}_{i} ) - {A}_{z} ( {x}_{i} , {y}_{i} - dy , {z}_{i} )}{2 dy} - \frac{{A}_{y} ( {x}_{i} , {y}_{i} + {z}_{i} + dx ) - {A}_{y} ( {x}_{i} , {y}_{i} , {z}_{i} - dz )}{2 dy} \} \qquad ( 27 )$$

Here, A_{z}(x,y,z) is a z-component of the vector potential A at a position represented by the coordinates (x, y, z). xᵢ, yᵢ, and zᵢ are an x-component, a y-component, and a z-component of the position vector rᵢ, respectively. dy is a minute displacement amount in the y direction. The minute displacement amounts dx, dy, and dz may be set to, for example, about 1/10 of the radius of a sphere having the same volume as the Voronoi polyhedron, or about 1/10 of the radius of a circle having the same area as the Voronoi polygon.

### Repeat Calculation

When the induced magnetic field H_{ind}(rᵢ) is updated, the total external magnetic field vector Hₒ(rᵢ) is updated from Expression (20). Further, the magnetization vector M(H) at the position of the i-th bead 15 is updated for all i by using Expression (21) or Expression (22). The magnetic moment mᵢ applied to the i-th bead 15 is updated with the updated magnetization vector M(H). The magnetic field vector Hₘ(rᵢ) is updated based on the updated magnetic moment mᵢ by using Expression (24).

A time change of the total external magnetic field vector Hₒ(rᵢ) can be obtained by repeating the same calculation, based on the updatedmagnetic field vector Hₘ(rᵢ) and the inducedmagnetic field vector H_{ind}(rᵢ).

Next, the excellent effect of the example described above will be described.

In the example described above, as shown in FIG. 4A, the analysis object 10 is divided into a plurality of beads 15 by Voronoi division. Therefore, the analysis object 10 is completely filled with the plurality of beads 15, and no gap is formed. Further, when numerically calculating the integral on the right side of Expression (16) , as shown in FIG. 4B, each of the beads 15 is divided into a plurality of triangular or triangular pyramid elements 16, and the numerical surface integration or volume integration is performed for each of the elements 16. Therefore, an integral is performed over the entire area of the bead 15. In contrast, in a case where the bead 15 is assumed to be a true circle or a true sphere and an integral is performed, a gap that is not included in any of the true circle or the true sphere is generated between the beads 15.

In the present example, since the surface integration or the volume integration is performed over the entire area of the bead 15 for all the beads 15, it is possible to prevent the occurrence of an error due to the occurrence of a gap.

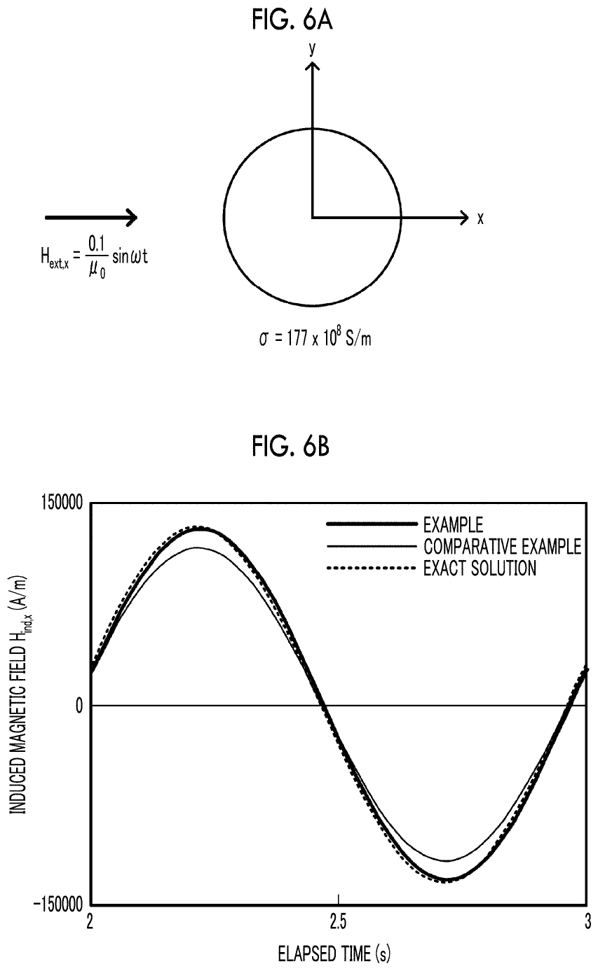

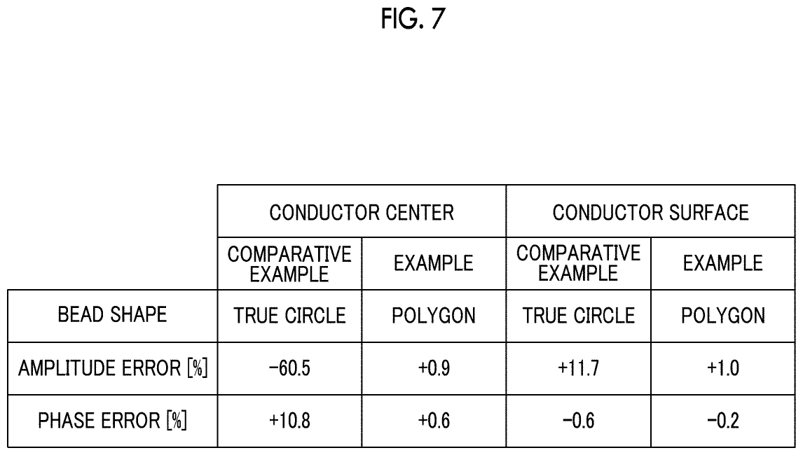

In order to confirm the excellent effect of the present example, the analysis of a magnetic field was performed using the analysis method according to the above example. The analysis result will be described with reference to FIGS. 6A to 7.

FIG. 6A is a schematic diagram showing an analysis model. A two-dimensional conductor column (that is, a circle) with a radius R is placed in an external magnetic field Hₑₓₜ that is spatially uniform and changes over time. The external magnetic field Hₑₓₜ has only the x-component.

A magnetic field Hₛᵤᵣ on the surface of the conductor column can be obtained analytically and is expressed by the following expression.

$${H}_{sur} = [ \{ 1 - \frac{2}{kR} \cdot \frac{{J}_{1} ( kR )}{{J}_{0} ( kR )} \} \{ 2 ( n \cdot {H}_{a} ) n - {H}_{a} \} ] {e}^{j ω t} \qquad ( 28 )$$

Here, Hₐ is the amplitude of the external magnetic field, J₀ and J₁ are the Bessel functions, n is a unit normal vector on the surface of the conductor column, and t is time. k is expressed by the following expression.

$$k = \frac{1 + j}{δ} \\ δ = \frac{1}{\sqrt{2 πσω}} \qquad ( 29 )$$

Here, j is an imaginary unit, σ is the conductivity of the conductor column, and co is the angular frequency of the external magnetic field.

The amplitude of the external magnetic field Hₑₓₜ was set to be 0.1 T/μₒ, and the angular frequency co was set to be 1 Hz. The radius R of the conductor column was set to be 0.01 m, the conductivity o was set to be 177×10⁸ S/m, and the induced magnetic field on the surface of the conductor column was obtained by the analysis method according to the present example and an analysis method according to a comparative example.

FIG. 6B is a graph showing the analysis results. The horizontal axis represents an elapsed time in the unit “second”, and the vertical axis represents the x-component H_{ind,x} of the induced magnetic field on the surface of the conductor column in the unit “A/m”. The thick solid line in the graph shows a solution in a case where the analysis method according to the present example is used, the thin solid line shows a solution in a case where the analysis method according to the comparative example is used, and the broken line shows an exact solution calculated using Expression (28). In the analysis method according to the comparative example, the method disclosed in the related art, that is, the surface integration of Expression (16) was performed by dividing an analysis object into a plurality of beads and assuming the bead to be a true sphere.

It can be seen that an error from the exact solution, of the solution obtained by the analysis method according to the present example is smaller than an error of the solution obtained by the analysis method according to the comparative example.

FIG. 7 is a chart showing the errors from the exact solution, of the solutions obtained by the analysis methods according to the example and the comparative example. In the comparative example, an amplitude error is 10% or more at both the conductor center and the conductor surface, and a phase error at the conductor center is also 10% or more. In contrast, in the example, the amplitude error and the phase error are 1% or less at both the conductor center and the conductor surface.

From the analysis results shown in FIGS. 6A to 7, it was confirmed that an error with respect to the exact solution can be sufficiently reduced by applying the analysis method according to the present example.

The example described above is exemplification, and the present invention is not limited to the example described above. For example, it will be obvious to those skilled in the art that various changes, improvements, combinations, and the like are possible.

It should be understood that the invention is not limited to the above-described embodiment, but may be modified into various forms on the basis of the spirit of the invention. Additionally, the modifications are included in the scope of the invention.

What is claimed is:

1. A magnetic field analysis method comprising:
dividing each of analysis objects of a system including at least one analysis object that is defined in a virtual space into a plurality of beads, each of which is a Voronoi polyhedron or a Voronoi polygon;
applying a magnetic moment to each of the plurality of beads; and
obtaining an induced magnetic field at a position of each of the plurality of beads when an external magnetic field changes over time,
wherein each of the plurality of beads is divided into a plurality of triangular pyramid elements each having each of a plurality of Voronoi surfaces of the Voronoi polyhedron as a bottom surface, or a plurality of triangular elements each having each of a plurality of sides of the Voronoi polygon as one side,
a vector potential at an observation point that is included in the virtual space is described as a function of an electromagnetic physical quantity in a minute region in the analysis object and a distance from the minute region to the observation point, and
the induced magnetic field at the observation point is obtained by numerically volume-integrating or surface-integrating the function of the vector potential for each of the elements obtained by division.

2. The analysis method according to claim 1, wherein when obtaining the induced magnetic field, an induced magnetic field expression is used which is derived by performing a gauge transformation that is described using a vector product of a centroid vector for each analysis object and a magnetic flux density in the virtual space with respect to the vector potential.

3. The analysis method according to claim 1, further comprising:
obtaining a force acting on each of the plurality of beads, based on the obtained induced magnetic field; and
obtaining a behavior of the at least one analysis object by numerically solving a motion equation that governs a motion of each bead, based on the force acting on each of the plurality of beads.

4. An analysis device comprising:
an input device to which an analysis condition is input; and
a processing device that performs analysis of a magnetic field, based on the analysis condition input to the input device,
wherein a vector potential at an observation point that is included in a virtual space is described as a function of an electromagnetic physical quantity in a minute region in an analysis object and a distance from an optional point in the minute region to the observation point,
the processing device is capable of
applying a magnetic moment to each of a plurality of beads,
dividing each of the analysis objects of a system including at least one analysis object that is defined in the virtual space into the plurality of beads, each of which is a Voronoi polyhedron or a Voronoi polygon, based on the analysis condition input to the input device, and
obtaining an induced magnetic field at a position of each of the plurality of beads when an external magnetic field changes over time, and
in the obtaining of the induced magnetic field,
each of the plurality of beads is divided into a plurality of triangular pyramid elements each having each of a plurality of Voronoi surfaces of the Voronoi polyhedron as a bottom surface, or a plurality of triangular elements each having each of a plurality of sides of the Voronoi polygon as one side, and
the induced magnetic field at the observation point is obtained by numerically volume-integrating or surface-integrating the function of the vector potential for each of the elements obtained by division.

5. A computer readable medium storing a program that causes a computer to execute a process for magnetic analysis, the process comprising:
dividing each of analysis objects of a system including at least one analysis object that is defined in a virtual space into a plurality of beads each of which is a Voronoi polyhedron,
applying a magnetic moment to each of the plurality of beads, and
obtaining an induced magnetic field at a position of each of the plurality of beads when an external magnetic field changes over time,
wherein a vector potential at an observation point that is included in the virtual space is described as a function of an electromagnetic physical quantity in a minute region in the analysis object and a distance from an optional point in the minute region to the observation point, and
the obtaining of the induced magnetic field includes
dividing each of the plurality of beads into a plurality of triangular pyramid elements each having each of a plurality of Voronoi surfaces of the Voronoi polyhedron as a bottom surface, or a plurality of triangular elements each having each of a plurality of sides of a Voronoi polygon as one side, and
obtaining the induced magnetic field at the observation point by numerically volume-integrating or surface-integrating the function of the vector potential for each of the elements obtained by division.
